(19) United States
(12) Patent Application Publication
(10) Pub. No.: US 2025/0178566 A1
(43) Pub. Date: Jun. 5, 2025

(54) Method for Producing a Three-Dimensionally Shaped Heating Film, Heating Film, Cover Pane for Headlights

(71) Applicant: Marelli Germany GmbH, Reutlingen (DE)

(72) Inventors: Sylvain Teysseyre, Reutlingen (DE); Alexander Klumpp, Reutlingen (DE)

(73) Assignee: Marelli Germany GmbH, Reutlingen (DE)

(21) Appl. No.: 18/968,611

(22) Filed: Dec. 4, 2024

(30) Foreign Application Priority Data
Dec. 5, 2023 (DE) 102023134034.4

(51) Int. Cl. B60S 1/02; F21S 45/60

(52) U.S. Cl. CPC B60S 1/026; F21S 45/60

(57) ABSTRACT

A method for producing a three-dimensionally shaped heating film, including the steps of: providing a substrate, which extends along a film plane and which has a first substrate region for receiving a heating wire and a second substrate region adjacent to the first substrate region, wherein, at least one contacting point is provided in the second substrate region; arranging at least one connector pad on the substrate in the first substrate region; arranging at least one heating wire on the substrate in the first substrate region; connecting the at least one connector pad and the at least one heating wire; forming the second substrate region to produce a three-dimensional shape deviating from the film plane; and arranging at least one additional pad on the substrate in the first substrate region and in the second substrate region in order to connect the contacting point and connector pad.

### CROSS-REFERENCE TO RELATED APPLICATIONS

The present application claims priority to and all the benefits of German Patent Application No. 102023134034.4, filed on Dec. 5, 2023, the entire contents of which are hereby expressly incorporated herein by reference.

### BACKGROUND OF THE INVENTION

### 1. Field of the Invention

The present invention is generally directed toward heating films and cover planes for headlights, and more specifically, toward a method for producing a three-dimensionally shaped heating film.

### 2. Description of the Related Art

DE 10 2016 111 493 A1 discloses a method for producing a printed circuit provided with a thermoforming film, wherein, in a thermoformed intermediate part, electrically conductive tracks are provided in a serpentine or zigzag shape.

Due to the stretching of the film and the electrically conductive tracks, the thermoforming can lead to the development of folds and to complete tearing of the tracks, such that they conduct electricity poorly or not at all.

### SUMMARY OF THE INVENTION

The invention relates to a method for producing a three-dimensionally shaped heating film, to a heating film, and to a cover pane.

Sensors, e.g., radar or lidar, for driver assistance systems are integrated into headlights, for example. Headlights have a cover pane through which the sensor signals must pass at least once. This requires that defined wavelengths can penetrate the cover pane in order to generate reliable sensor data. For the sensor types mentioned, ice and dew, for example, are critical. The ability of the sensor signals to reliably pass through the cover pane is ensured, for example, by, inter alia, a heater in the cover pane.

Cover panes have strong curvatures and/or strong offsets to the hood and/or to the bumper. For this reason, the components provided on or in the cover pane must also implement these curvatures and offsets.

The invention therefore has the object of providing a method for producing a three-dimensionally shaped heating film, in which method the components provided on the heating film are not damaged.

The object achieved by the invention is likewise achieved by a method including the steps of: providing a substrate, which extends along a film plane and which has a first substrate region for receiving a heating wire and a second substrate region adjacent to the first substrate region, and providing at least one contacting point in the second substrate region; arranging at least one connector pad on the substrate in the first substrate region; arranging at least one heating wire on the substrate in the first substrate region; connecting the at least one connector pad and the at least one heating wire; forming the second substrate region to produce a three-dimensional shape deviating from the film plane; and arranging at least one additional pad, which in particular is separate from the connector pad, on the substrate in the first substrate region and in the second substrate region in order to connect the at least one contacting point and the at least one connector pad.

Due to the multi-part nature of the connector pad and the additional pad, they can be arranged separately, in particular at different production times. If the connector pad is first applied in the first substrate region and then the second substrate region is formed, and subsequently the additional pad is applied to the first and second substrate regions, neither the connector pad nor the additional pad can be damaged by strong forming in the forming process. The connector pad and/or the additional pad is preferably not formed. Consequently, the electrical connection of the first substrate region and the second substrate region is made after the forming of the second substrate region. This ensures that the additional pad is applied gently. Accordingly, it is ensured that the first substrate region, in particular the heating wires, and the second substrate region, in particular the contacting point, are electrically connected to one another.

For the purposes of the invention, a three-dimensional shape is understood to be a shape which deviates, at least in parts, from a plane shape. The three-dimensional shape may, for example, have a plane part and an elevation and/or a pocket. In this case, the plane part is undeformed or deformation-free or not formed, and the elevation and/or pocket is deformed or formed. The plane part remains in a plane, and the elevation and/or the pocket is spaced apart from the plane. Components arranged on the first plane part are protected because they are not formed.

It is advantageous if the substrate, in particular the substrate region and/or the second substrate region, and/or the at least one heating wire and/or the at least one connector pad and/or the at least one additional pad is overmolded. The overmolding can comprise an IMD (in-mold decoration) process or an FIM (film insert molding) process. The overmolding preferably takes place after the forming. An overmolding material, in particular PC or PET, can be used for the overmolding.

It is also advantageous if the at least one connector pad is glued and/or soldered to the substrate, in particular to the first substrate region. The connector pad can preferably be in the form of a copper pad. The connector pad can preferably be arranged on a double-sided adhesive pad.

Preferably, the forming of the second substrate region comprises thermal forming and/or thermal deep drawing, in particular vacuum thermoforming and/or high press forming.

An advantageous further development provides that the forming of the second substrate region be carried out in such a way that, after the forming, the second substrate region is arranged, at least in parts, at an angle of more than 30°, in particular of more than 45°, and preferably of more than 60°, to the film plane. Due to the low expansion capacity, a connection pad, for example, a copper pad, arranged on in the second substrate region would develop folds and/or tear, which would interrupt the electrical connection. By attaching the connector pad and the additional pad in several steps, it is ensured that, even in the case of such angles, the connector pad and the additional pad do not develop folds and/or tear.

It is advantageous if an offset of the substrate, i.e., an edge region of the second substrate region adjacent to the first substrate region, has an angle of more than 30°, in particular more than 45°, and preferably more than 60°, to the film plane. In one embodiment, the additional pad is applied to the substrate after the forming or after the production of the offset. Consequently, the additional pad is not damaged due to the forming, in particular the strong forming at the offset. It is conceivable that, in the first substrate region and in the second substrate region, at least one connector pad is arranged, and, only in the region of the offset, no connector pad is provided. After the forming, the additional pad, by being arranged on the offset, can bridge the connector pad arranged in the first and second substrate regions.

In one embodiment, the arranging of the heating wires on the substrate includes an ultrasonic process, for example an ultrasonic welding process. The at least one heating wire may be electrically connected to the at least one connector pad.

It is advantageous if the at least one additional pad is glued and/or soldered to the substrate, for example, to the first substrate region and the second substrate region. The additional pad can be in the form of a copper pad. The additional pad can also be arranged on a double-sided adhesive pad.

To further improve the durability of the additional pad, it can be arranged in a meandering shape on the substrate, especially in the offset.

It is also advantageous if the at least one additional pad is arranged to overlap on the at least one connector pad, and/or the additional pad is glued and/or soldered to the connector pad. This ensures that there is a secure electrical connection between the connector pad and the additional pad.

To arrange the at least one additional pad on the substrate, a rolling and/or stamping process can be carried out using a rolling and/or stamping tool. A rolling and/or stamping process is simple and fast. Due to the overlapping of the additional pad and the connector pad, high accuracy in the arranging is not required.

The object of the invention is achieved by a heating film that is produced in a previously described method.

The heating film may include: at least one three-dimensional substrate having a first substrate region, extending along a film plane, and having a three-dimensionally deformed second substrate region deviating from the film plane, at least one connector pad arranged on the substrate in the first substrate region, at least one heating wire arranged on the substrate in the first substrate region and electrically connected to the connector pad, at least one contacting point arranged in or on the substrate in the second substrate region, and at least one additional pad arranged on the substrate in the first substrate region and in the second substrate region and electrically connecting the at least one connector pad and the at least one contacting point.

It is advantageous if the connector pad and/or the additional pad is designed to be deformation-free, i.e., was not deformed when the second substrate region was deformed.

It is also advantageous if the substrate and/or the at least one heating wire and/or the at least one connector pad and/or the at least one additional pad is overmolded with a potting compound, wherein in particular the potting compound comprises PC and/or PET.

In one embodiment, the at least one connector pad and/or the at least one additional pad may each be in the form of a copper pad.

It is advantageous if the at least one connector pad and/or the at least one additional pad are electrically connected to one another via a soldering point.

It is also advantageous if the second substrate part is arranged, at least in parts, at an angle of more than 30°, in particular of more than 45°, and preferably of more than 60°, to the film plane.

In one embodiment, the second substrate region has an offset which is formed by an edge region, adjacent to the first substrate region, of the second substrate region. For example, the offset may be arranged at an angle of more than 30°, and, in one embodiment, more than 45°, and, in another embodiment, more than 60°, to the film plane. The second substrate region may include a flat part, which may be substantially parallel to and spaced apart from the film plane. It is conceivable that a connector pad can be arranged in the flat part even before the forming. In this case, the additional pad bridges only the offset.

The present invention is also directed to a heating film including: at least one three-dimensional substrate having a first substrate region, extending along a film plane, and having a three-dimensionally deformed second substrate region deviating from the film plane, at least one connector pad arranged on the substrate in the first substrate region, at least one heating wire arranged on the substrate in the first substrate region and electrically connected to the connector pad, at least one contacting point arranged in or on the substrate in the second substrate region, and at least one additional pad arranged on the substrate in the first substrate region and in the second substrate region and electrically connecting the at least one connector pad and the at least one contacting point, wherein the connector pad and the additional pad are separate from one another.

The object of the invention is likewise achieved by a cover pane for a headlight having a heating film of the type described above. The present invention is also directed to a radome having a previously described heating film.

The present invention is also directed to a method for producing a three-dimensional circuit of an LED lighting device, for example for a vehicle, e.g., to create a headlight, a turn signal, an external decorative lighting element, a lighting device inside the passenger compartment, a backlight device for a display and/or for control buttons provided on a dashboard of the vehicle, etc. Instead of the heating wires, electric tracks are used. In this case, the electric tracks serve essentially to electrically connect components, in particular a light source, and not to generate heat.

This method includes the steps of: providing a substrate, which extends along a film plane and which has a first substrate region for receiving an electrically conductive track and a second substrate region adjacent to the first substrate region, wherein at least one contacting point is provided in the second substrate region; arranging at least one connector pad on the substrate in the first substrate region; arranging at least one electrically conductive track on the substrate in the first substrate region; connecting the at least one connector pad and the at least one electrically conductive track; forming the second substrate region to produce a three-dimensional shape deviating from the film plane; and arranging at least one additional pad, which may be separate from the connector pad, on the substrate in the first substrate region and in the second substrate region in order to connect the at least one contacting point and the at least one connector pad.

The circuit may also include a light source on the substrate. The at least one electrically conductive track can preferably be electrically connected to the light source.

The present invention is also directed toward a three-dimensional circuit produced by the method.

Further details and advantageous embodiments of the invention can be found in the following description, by which exemplary embodiments of the invention are further described and explained.

### BRIEF DESCRIPTION OF THE DRAWINGS

In the drawings:

FIG. 1 shows a flowchart of a method according to the invention;

FIG. 2 shows a schematic top view of an undeformed substrate with heating wires and copper pads;

FIG. 3 shows a sectional view of a vehicle with a cover pane of a headlight;

FIG. 4 shows a schematic perspectival view of a deformed substrate with deformed connector pads, as known from the prior art;

FIG. 5 shows a schematic perspectival view of a deformed substrate with undeformed connector pads; and

FIG. 6 shows a schematic perspectival view of a deformed substrate with undeformed connector pads and undeformed additional pads.

### DETAILED DESCRIPTION OF THE INVENTION

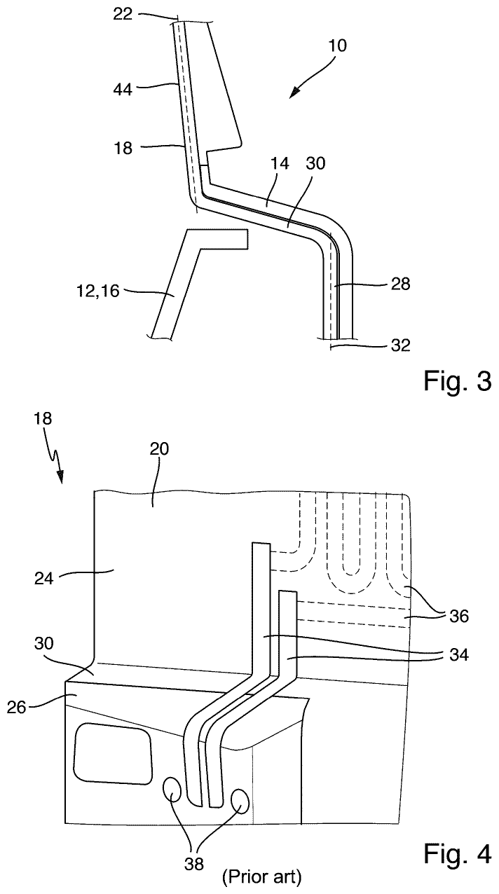

According to FIG. 3, a headlight 10 of a vehicle 12 has a cover pane 14 which is formed onto a bumper 16 and/or onto a hood (not shown). Sensors (not shown), used, for example, in a driver assistance system, are provided in the headlight 10. The sensor signals of the sensors pass through the cover pane 14 at least once. This requires that defined wavelengths be able to penetrate the cover pane 14 in order to generate reliable sensor data. For the sensors, ice and dew, for example, are critical. The function of the sensor is ensured, for example, by, inter alia, a heater in the cover pane 14.

The heater is provided by a heating film 18. According to FIGS. 4 to 6, the heating film 18 has a three-dimensional substrate 20 having a first substrate region 24, extending along a film plane 22, and having a three-dimensionally deformed second substrate region 26 deviating from the film plane 22. The second substrate region 26 is further divided into a plane flat region 28 and an offset 30, wherein the offset 30 is formed by the edge region, adjacent to the first substrate region 24, of the second substrate region 26. The flat region 28 extends along a deformation plane 32, wherein the deformation plane 32 may extend substantially parallel to the film plane 22. The second substrate region 26 can be in the form of an elevation and/or a pocket and/or a step, wherein the offset 30 forms the at least one side wall of the elevation and/or of the pocket and/or of the step.

According to FIG. 3, the offset 30 may be arranged at an angle of more than 30°, or, in one embodiment, at an angle of more than 45°, or in still another embodiment at an angle of more than 60°, to the film plane 22.

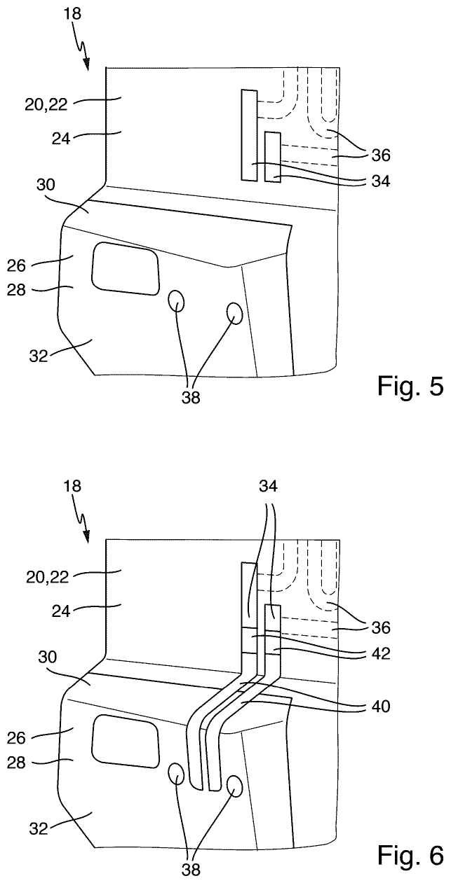

According to FIGS. 5 and 6, two connector pads 34 are arranged on the substrate 20 in the first substrate region 24. The connector pads 34 are preferably arranged at a distance from the second substrate region 26. The connector pads 34 are glued and/or soldered to the substrate 20. The connector pads 34 are made of copper. The connector pads 34 preferably run parallel to the film plane 22.

According to FIGS. 5 and 6, two heating wires 36 are arranged on the substrate 20 in the first substrate region 24. The heating wires may be electrically connected to the connector pads 34. The heating wires 36 may be made of copper. The heating wires may be applied to the substrate 20 using an ultrasonic welding process. In one embodiment, the heating wires 36 are also electrically connected to the connector pads 34. Alternatively, the heating wires 36 are glued and/or soldered to the connector pads 34. In one embodiment, the heating wires 36 extend parallel to the film plane 22. FIG. 2 shows the arrangement of three heating wires 36 on an undeformed substrate 20, i.e., one extending along the film plane 22. The heating wires 36 run parallel to each other, at least in parts. At each end, the heating wires 36 end in a connector pad 34.

In addition, as best shown in FIGS. 5 and 6, two contacting points 38 for connection to a plug (not shown) are arranged on the substrate 20 in the second substrate region 24.

Furthermore, as best shown in FIG. 6, additional pads 40 are arranged on the substrate 20. The additional pads extend over the first substrate region 24 and the second substrate region 26. The additional pads 40 connect the contacting points 38 and the connector pads 34, and thus also the heating wires 36. The additional pads 40 may be glued and/or soldered to the substrate 20. The additional pads 40 and the connector pads 34 are electrically connected to one another via a soldering point 42.

If the second substrate region 26 has a flat region 28 with a shape or with a shape that deviates slightly from a plane shape, then it is also conceivable that at least one connector pad 34 be provided in the first substrate region 24, and at least one connector pad 34 be provided in the second substrate region 26. In this case, the additional pad 40 bridges only the offset 30 in order to connect the connector pad 34 in the first substrate region 24 and the connector pad 34 in the second substrate region 26.

The heating wires 36 can be replaced by electrically conductive tracks. The additional pads 40 then serve to connect the contacting points 38 to an electronic component, for example, to a light source, such as an LED or an OLED.

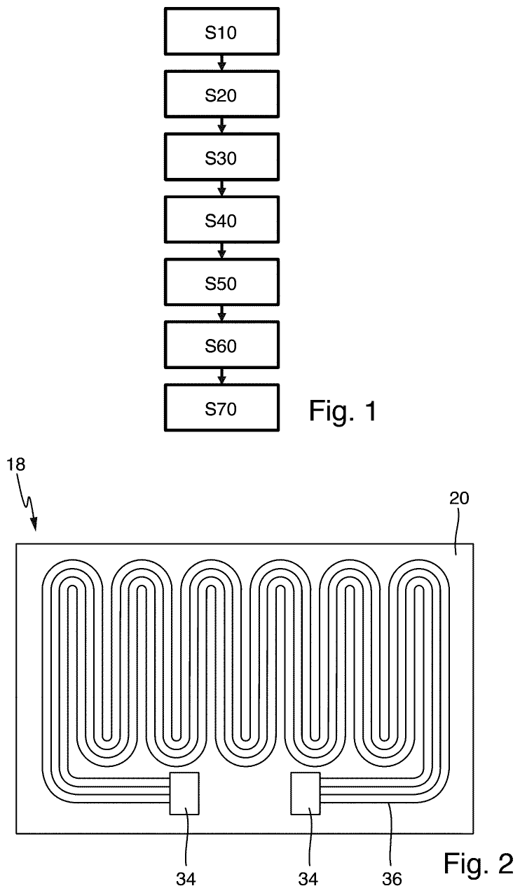

To produce the three-dimensionally shaped heating film 18, according to FIG. 1, a substrate 20, which extends along a film plane 22 and which has a first substrate region 24 for receiving at least one heating wire 36 and a second substrate region 26 adjacent to the first substrate region 24, is first provided. At least one contacting point 38 is provided in the second substrate region 26 (S10).

At least one connector pad 34 is arranged, for example, glued and/or soldered, on the substrate 20 in the first substrate region 24 (S20).

Furthermore, at least one heating wire 36 is arranged on the substrate 20 in the first substrate region 24, for example, connected to the substrate 20 using an ultrasonic welding process (S30). The at least one heating wire 36 may also be electrically connected to the at least one connector pad 34 (S40). Consequently, steps S30 and S40 can also be represented as one step.

Subsequently, the second substrate region 26 is formed in a first forming process to produce a three-dimensional shape deviating from the film plane 22 (S50). The substrate 20 is brought into the desired shape using thermoforming, for example, high pressure forming and/or vacuum thermoforming. High pressure forming may be used due to its higher precision. The shape of the heating film 18, in particular of the substrate 20, is formed to the geometry of the cover pane 14. An offset 30 is created in the second substrate region 26. The offset being may be arranged at an angle of more than 30°, and, in one embodiment, more than 45° and, in another embodiment, more than 60°, to the film plane 22. In addition, a plane flat region 28 can be produced in the second substrate region 26. In one embodiment, the contacting points 38 are arranged in the flat region 28. The second substrate region 26 can be in the form of an elevation and/or a pocket and/or a step, wherein the offset 30 forms the at least one side wall of the elevation and/or of the pocket and/or of the step.

Subsequently, at least one additional pad 40 is arranged on the substrate 20 in the first substrate region 24 and in the second substrate region 26 to connect the at least one contacting point 38 and the at least one connector pad 34 (S60). The additional pad 40 is applied to the substrate 20 in a second forming process, for example, using a rolling and/or stamping process. The additional pad 40 can then be glued and/or soldered to the substrate 20. In one embodiment, the additional pad 40 is arranged on the substrate 20 such that the additional pad 40 overlaps with the connector pad 34 at least in parts. The additional pad 40 and the connector pad 34 may be connected to each other using a soldering point 42.

The heating film 18, in particular the substrate 20 and/or the connector pad 34 and/or the heating wire 36 and/or the additional pad 40, is then overmolded, for example, using a potting compound 44, such as PC or PET. The overmolding may include in-mold decoration or film insert molding.

In the prior art, the connector pad 34 is applied to the first substrate region 24 and the second substrate region 26 before the forming. According to FIG. 4, warping, folds, and/or tears then occur at the connector pad 34, in particular in the region of the offset 30, during the forming.

Because the connector pad 34 and the additional pad 40 are formed separately, they can be arranged separately, for example, at different production times (S20, S60). Nevertheless, the heating wires 38 can be applied to the substrate 20 before the forming. If the connector pad 34 is first applied in the first substrate region 24 and then the second substrate region 26 is formed, and subsequently the additional pad 40 is applied to the first substrate region 24 and the second substrate region 26, neither the connector pad 34 nor the additional pad 40 can be damaged by strong forming in the forming process of the substrate 20. In this case, the connector pad 34 is not formed. The additional pad 40 may be formed onto the substrate 20 in a second forming process that is separate from the first forming process. The second forming process can be adapted to the properties of the additional pad 40 such that no warping, folds, and/or tears occur at the additional pad 40. Consequently, the electrical connection of the first substrate region 24 and the second substrate region 26 is made after the forming of the second substrate region 26. This ensures that the additional pad 40 is applied gently. Accordingly, it is ensured that the first substrate region 24, for example, the heating wires 36, and the second substrate region 26, for example, the contacting point 28, are electrically connected to one another.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. A method for producing a three-dimensionally shaped heating film, comprising the steps of:
providing a substrate, which extends along a film plane and which has a first substrate region for receiving a heating wire and a second substrate region adjacent to the first substrate region, and providing at least one contacting point in the second substrate region;
arranging at least one connector pad on the substrate in the first substrate region;
arranging at least one heating wire on the substrate in the first substrate region;
connecting the at least one connector pad and the at least one heating wire;
forming the second substrate region to produce a three-dimensional shape deviating from the film plane; and
arranging at least one additional pad on the substrate in the first substrate region and in the second substrate region in order to connect the at least one contacting point and the at least one connector pad.

2. The method as set forth in claim 1, wherein the substrate and/or the at least one heating wire and/or the at least one connector pad and/or the at least one additional pad is overmolded.

3. The method as set forth in claim 1, wherein the at least one connector pad is glued and/or soldered to the substrate.

4. The method according as set forth in claim 1, wherein the forming of the second substrate region comprises thermal forming and/or thermal deep drawing.

5. The method as set forth in claim 1, wherein after forming the second substrate region, the second substrate region is arranged, at least in parts, at an angle of more than 30°, in particular of more than 45°, and preferably of more than 60°, to the film plane.

6. The method as set forth in claim 1, wherein the arranging of the heating wires on the substrate comprises an ultrasonic process.

7. The method as set forth in claim 1, wherein the at least one additional pad is glued and/or soldered to the substrate.

8. The method as set forth in claim 1, wherein the at least one additional pad is arranged in a meandering shape on the substrate.

9. The method as set forth in claim 1, wherein the at least one additional pad is arranged to overlap on the at least one connector pad, and/or the additional pad is glued and/or soldered to the connector pad.

10. The method as set forth in claim 1, wherein the arranging of the at least one additional pad on the substrate comprises a rolling and/or stamping process.

11. A heating film produced using the method as set forth in claim 1, wherein the heating film comprises:
at least one three-dimensional substrate having a first substrate region, extending along a film plane, and having a three-dimensionally deformed second substrate region,
at least one connector pad arranged on the substrate in the first substrate region,
at least one heating wire arranged on the substrate in the first substrate region and electrically connected to the connector pad,
at least one contacting point arranged in or on the substrate in the second substrate region, and
at least one additional pad arranged on the substrate in the first substrate region and in the second substrate region and electrically connecting the at least one connector pad and the at least one contacting point.

12. The heating film as set forth in claim 11, wherein the substrate and/or the at least one heating wire and/or the at least one connector pad and/or the at least one additional pad is overmolded with a potting compound, wherein the potting compound comprises, in particular, PC and/or PET.

13. The heating film as set forth in claim 11, wherein the at least one connector pad and/or the at least one additional pad are each in the form of a copper pad.

14. The heating film as set forth in claim 11, wherein the at least one connector pad and/or the at least one additional pad are electrically connected to one another by a soldering point.

15. The heating film as set forth in claim 11, wherein the second substrate part is arranged, at least in parts, at an angle of more than 30°, in particular of more than 45°, and preferably of more than 60°, to the film plane.

16. A cover pane for a headlight having a heating film as set forth in claim 11.
